(19) United States
(12) Patent Application Publication
(10) Pub. No.: US 2022/0311066 A1
(43) Pub. Date: Sep. 29, 2022

(54) METHOD OF ESTIMATING STATE OF DETERIORATION OF BATTERY

(71) Applicant: TOYOTA JIDOSHA KABUSHIKI KAISHA, Toyota-shi Aichi-ken (JP)

(72) Inventor: Keita Komiyama, Okazaki-shi Aichi-ken (JP)

(21) Appl. No.: 17/688,127

(22) Filed: Mar. 7, 2022

(30) Foreign Application Priority Data
Mar. 25, 2021 (JP) 2021-051319

(51) Int. Cl. H01M 10/48; G01K 3/10

(52) U.S. Cl. CPC H01M 10/486; G01K 3/10

(57) ABSTRACT

Provided is a method of estimating a state of deterioration of a battery with higher accuracy. The method includes: calculating a difference between a temperature T₁ when temperature begins to drop, and a temperature T₂ when the temperature begins to rise and defining the difference as a temperature difference ΔT₁₂ if the following are satisfied concerning a battery having current collector foil and an outer casing: the temperature of the battery drops; and the rate at which the temperature changes, the range in which the temperature drops, and the range of the temperature are each a predetermined value; accumulating the number of times when a condition of the temperature belongs to any of classifications of the T₁ and the ΔT₁₂; and estimating damage to the current collector foil based on respective relationships between the classifications and damage to the current collector foil.

### CROSS-REFERENCE TO RELATED APPLICATIONS

This application is based upon and claims the benefit of priority of the prior Japanese Patent Application No. 2021-051319 filed Mar. 25, 2021, the entire contents of which are incorporated herein by reference.

### FIELD

The present disclosure relates to a method of estimating a state of deterioration of a battery.

### BACKGROUND

Patent Literature 1 discloses a control method of estimating the amount of deterioration of a battery from a value of accumulation of information on temperatures that the battery has got, and the rate of deterioration in relation to the temperatures.

### CITATION LIST

### Patent Literature

Patent Literature 1: JP 2019-100971 A

### SUMMARY

### Technical Problem

When a state of deterioration of a battery such as an all-solid-state battery is estimated, a degree of the deterioration cannot be accurately estimated only from information on temperatures as Patent Literature 1 because there is influence of various factors.

The present disclosure was made in view of the above circumstances, and an object thereof is to provide a method with higher accuracy which is capable of estimating a state of deterioration of a battery.

### Solution to Problem

The inventor conceived such an idea that the following should be also considered into estimation of a state of deterioration of a battery: an all-solid-state battery formed by containing an electrode stack in a laminated film that is an outer casing as, for example, schematically shown in FIG. 1 may deteriorate because variations in the internal pressure in the laminated film due to a temperature difference (ΔT) cause any protruded portion of the laminated film to be repeatedly in contact with any outer layer part (current collector foil) of the electrode stack to break the current collector foil. The inventor embodied this.

As one aspect to solve the above problem, the present application discloses a method of estimating a state of deterioration of a battery having an electrode stack having current collector foil, and an outer casing containing the electrode stack, the method comprising: calculating a difference between a temperature T₁ when temperature begins to drop, and a temperature T₂ when the temperature begins to rise and defining the difference as a temperature difference ΔT₁₂ if the following are all satisfied based on detected information on the temperature: the temperature of the battery drops; the temperature changes at a predetermined rate; the temperature drops in a predetermined range or wider; and the temperature is in a predetermined temperature range or under; classifying the T₁ and the ΔT₁₂, and accumulating a number of times when a condition of the temperature belongs to any of the classifications; and estimating damage to the current collector foil at present based on respective relationships between the classifications and damage to the current collector foil, the relationships being obtained in advance.

### Effects

The application of the estimation of a state of deterioration of a battery according to the present disclosure in addition to conventional estimation of a state of deterioration of a battery (for example, estimation of a state of deterioration of a battery as Patent Literature 1) can improve the accuracy of estimation of a state of deterioration of a battery.

### BRIEF DESCRIPTION OF DRAWINGS

FIG. 1 explanatorily shows a structure of a battery;

FIG. 2 is a flow of a method S10 of estimating a state of deterioration of a battery;

FIG. 3 is a graph explanatorily showing calculation of a temperature difference ΔT₁₂;

FIG. 4 shows an example of classification of T₁ and ΔT₁₂;

FIG. 5 explanatorily shows classification of T₁ and ΔT₁₂, and data created by arranging the relationship between the number of times and damage in each classification; and

FIG. 6 is a flow of a method S20 of estimating a state of deterioration of a battery.

### DESCRIPTION OF EMBODIMENTS

Hereinafter a method of estimating a state of deterioration of a battery according to the present disclosure will be described, using embodiments.

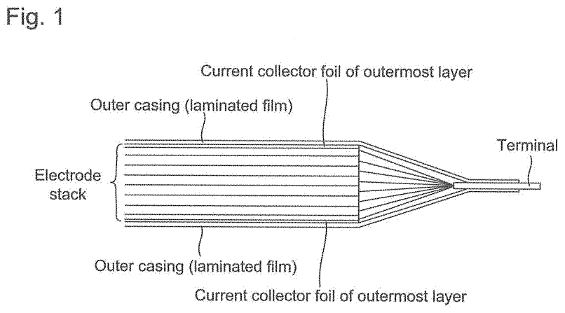

These embodiments will be described, using an all-solid-state battery as an example. The all-solid-state battery is as known: a cathode layer, an anode layer, and a solid electrolyte layer disposed between the cathode layer and the anode layer make a set to form a battery cell; and a plurality of the battery cells are stacked to form a battery stack as in FIG. 1. Here, each cathode layer is provided with a cathode current collector (current collector foil) made of metal foil, each anode layer is provided with an anode current collector (current collector foil) made of metal foil, and current collector foil is disposed on the outermost layers of the battery stack.

Such a battery stack is contained in an outer casing (laminated film) to be the all-solid-state battery.

A device configured to calculate a state of deterioration according to the method of estimating a state of deterioration of a battery of the present disclosure is not particularly limited, but a typical example thereof is an electronic control unit (hereinafter “ECU”) to control charge and discharge of a battery while the ECU monitors the state (current, voltage, temperature, etc.) of the battery. Any program having steps corresponding to respective steps in the following estimation method is stored in the ECU. A processing unit (CPU) included in the ECU operates according to this program, to execute the program.

[First Aspect]

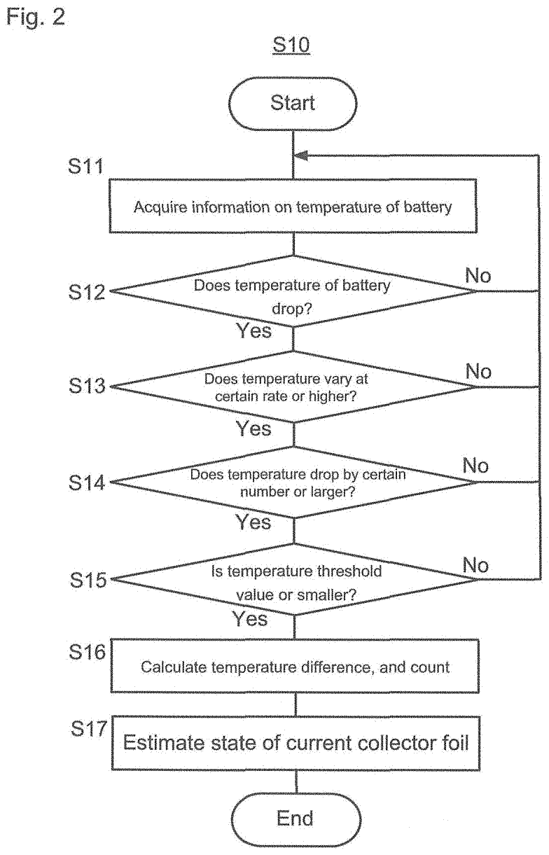

FIG. 2 shows a flow of a method S10 of estimating a state of deterioration of a battery according to the first embodiment (hereinafter may be referred to as “estimation method S10”). As can be seen from FIG. 2, the estimation method S10 includes Steps S11 to S17. Hereinafter each step will be described.

In Step S11, information on the temperature of the all-solid-state battery is acquired. The temperature information is periodically (e.g., every 30 minutes) acquired whether the battery is being used (during discharge or during charge) or on standby (during spontaneous discharge).

In Steps S12 to S15, the state of the temperature, which the temperature information obtained in Step S11 has, is determined. In the present disclosure, a condition for a state of the temperature to be considered is to satisfy the following. These are determined in Steps S12 to S15:

Step S12: the temperature of the all-solid-state battery drops compared to that in the last thermometry (the temperature of the battery drops);

Step S13: the temperature drops at a rate of a certain number or larger (the temperature varies at a certain rate or higher); Step S14: the temperature drops by a certain number or larger (the temperature drops in a certain range or wider); and

Step S15: the temperature reaches a certain temperature range or under (the temperature reaches at most a threshold value).

If the foregoing four conditions of the state of the temperature are satisfied, the state of the temperature, which the temperature information obtained in Step S11 has, is determined to be considered in the estimation of a state of deterioration of the all-solid-state battery, and the process moves to Step S16. If any of the temperature conditions is not satisfied, the process does not move to Step S16, but returns to Step S11 to continue to acquire the information on the temperature of the all-solid-state battery and store the temperature information.

This is based on the findings that: variations in the internal pressure inside the outer casing due to the temperature change cause any protruded portion of the outer casing to be in contact with any current collector foil; and repetition of this contact causes fatigue fracture in the current collector foil to break the current collector foil, which causes an internal short circuit of the battery to affect the state of deterioration of the battery. One example of a condition for such variations in the internal pressure such as to affect contact, especially fatigue fracture in the current collector foil is at least a certain temperature drop. Thus, it is specified to satisfy the conditions for determination as Steps S12 to S14.

Here, a specific rate of the temperature drop in Step S13 is not particularly limited as long as having a necessary magnitude for estimating the state of deterioration of the battery. Because a more rapid temperature change affects the deterioration more, a somewhat high rate of the temperature drop may be assumed (for example, any of −5° C./min and higher).

A specific range of the temperature drop in Step S14 is not particularly limited as long as being a necessary range for estimating the state of deterioration of the battery. From the viewpoint that a temperature change in a wider range affects the deterioration more, a somewhat wide range of the temperature may be assumed.

A specific temperature of the threshold value in Step S15 is not particularly limited as long as being a necessary temperature for estimating the state of deterioration of the battery. From the viewpoint that the amount of the deterioration is larger especially in a lower temperature range, the foregoing temperature may be set in a relatively low temperature (e.g., any of 0° C. and lower).

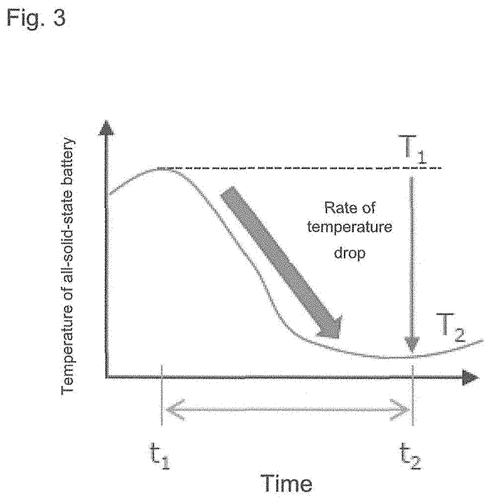

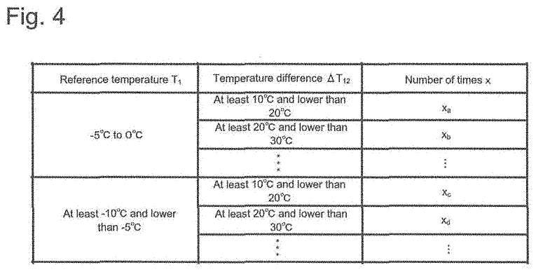

In Step S16, the temperature difference is calculated, and the rate of the temperature change is calculated and counted, using the information on the temperature of the all-solid-state battery, which is obtained until Step S15. FIGS. 3 and 4 are explanatory views.

The temperature difference is calculated as follows: a temperature T₁ that begins to drop (a temperature immediately after dropping), and a temperature T₂ that begins to rise (a temperature immediately before rising) are obtained from the information on the temperature of the all-solid-state battery obtained until Step S15; and a temperature difference ΔT₁₂ is calculated from the difference therebetween, T₁−T₂.

The rate of the temperature change is calculated as follows: further using a time t₁ it takes for the temperature to be the temperature T₁, and a time t₂ it takes for the temperature to be the temperature T₂, a time difference Δt₁₂ that is |t₁−t₂| is obtained; and ΔT₁₂/Δt₁₂ is calculated to be defined as a rate of the temperature change, V₁₂.

In the counting, the obtained rate of the temperature change V₁₂ of a certain number or larger is counted, and that less than a certain number is not counted. Here, counting means adding the number of times. A threshold value of the rate of the temperature change to be counted is not particularly limited, but may be selected from any values suitable for estimating the state of deterioration of the battery.

A way of the counting is not particularly limited. For example, as shown in FIG. 4, a temperature range to which T₁ belongs is further classified according to ranges for the temperature difference ΔT₁₂, and the number of times is obtained by each of the classifications. This makes it possible to classify the temperature change in a predetermined range (magnitude) in a predetermined range of the temperature, and at the same time to obtain the number of times, at a predetermined rate of the temperature change.

Information obtained through arrangement as described above is defined as information on accumulated temperature difference.

In Step S17, a current damage value of the all-solid-state battery is obtained based on the relationships between the numbers of times and the damage values, which are obtained in advance as classified by the reference temperature T₁ and the temperature difference ΔT₁₂, to estimate actual damage. More details are as follows.

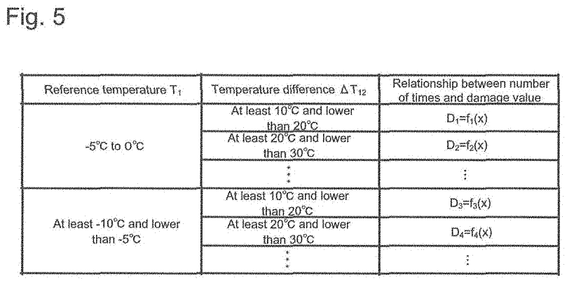

For example, the relationships between the numbers of times and the damage values, which are obtained in advance, may be arranged as in FIG. 5. That is, the relationships are classified by the reference temperature T₁ and the temperature difference ΔT₁₂, and the damage value (D) for each of the classification is obtained from a function (D=f(x)) where the number (x) of times is a variable.

Further, the relationship between the damage value obtained as a numerical value and an actual state of damage to the current collector foil is made to be clear by an experiment or the like. Specifically, for example, a damage value when the current collector foil brakes is obtained.

In Step S16, a damage Dₚ to the current collector foil at present is calculated as follows from the information on accumulated temperature difference obtained as shown in FIG. 4.

Dₚ=f₁(xₐ)+f₂(x_{b})+ . . . +f₃(x_{c})+f₄(x_{d})+

This Dₚ is a damage value Dₚ of the all-solid-state battery to be estimated, at present.

An actual state of the current collector foil of the all-solid-state battery to be estimated is estimated from the damage value Dₚ obtained based on the relationship between the damage value and the actual state of damage to the current collector foil, which is obtained in advance. For example, if Dₚ exceeds the damage value when the current collector foil brakes, it is estimated that the current collector foil breaks.

[Second Aspect]

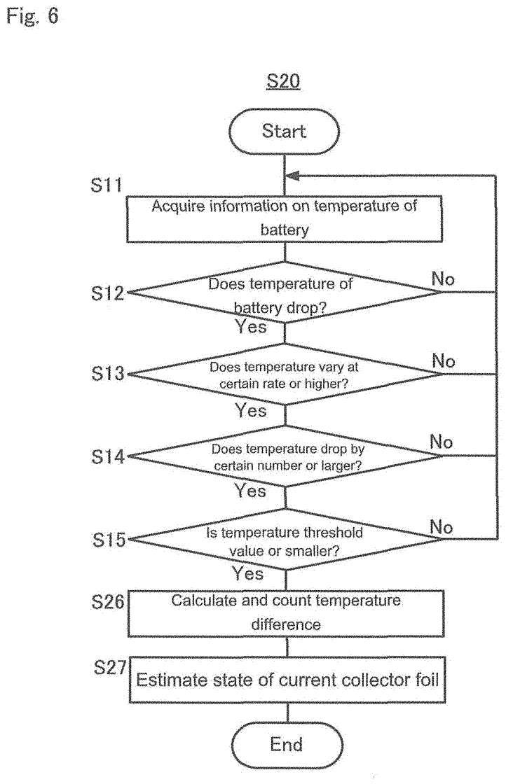

FIG. 6 shows a flow of a method S20 of estimating a state of deterioration of a battery according to the second embodiment (hereinafter may be referred to as “estimation method S20”). Steps S11 to S15 in the estimation method S20 are the same as in the estimation method S10, and thus are denoted by the same reference signs, and description thereof will be omitted. The estimation method S20 includes Steps S26 and S27 after Step S15.

In Step S26, the temperature difference is calculated and counted, using the information on the temperature of the all-solid-state battery, which is obtained until Step S15.

The temperature difference is calculated as shown in FIG. 3. That is, the temperature T₁, which is immediately after beginning to drop, and the temperature T₂, which is immediately before beginning to rise, are obtained from the data on the temperature of the all-solid-state battery obtained until Step S15; and the temperature difference ΔT₁₂ is calculated from the difference therebetween, T₁−T₂.

In the counting, the obtained temperature difference ΔT₁₂ of a certain threshold value ΔTₛ or larger is counted, and that less than this threshold value is not counted. Here, counting means adding the number of times.

Here, the threshold value ΔTₛ is determined by such experimental data in advance that how many times ΔTₛ or more is loaded to the battery to break the current collector foil. That is, specific data showing that the current collector foil brakes when ΔTₛ or more is loaded to the battery at least xₛ times is obtained. This data is not necessary to be one piece. Data on a plurality of combinations of different ΔTₛ and xₛ may be obtained.

In Step S27, the data on combination of ΔTₛ and xₛ, which is obtained in advance, and the number of times when ΔT₁₂ is ΔTₛ or more, which is obtained in Step S26, is compared, to estimate the actual damage to the all-solid-state battery (current collector foil) to be estimated. For example, if the number of times when ΔT₁₂ is ΔTₛ or more exceeds the number xₛ of times when the current collector foil breaks, it is estimated that the current collector foil brakes.

### Effect Etc.

The method of estimating a state of deterioration of a battery according to the present disclosure makes it possible to consider deterioration caused by the current collector foil due to the temperature change. The application of this in addition to conventional estimation of a state of deterioration of a battery (estimation of a state of deterioration of a battery caused by any constituent members other than the current collector foil, in relation to the temperature change) can improve the accuracy of estimation of a state of deterioration of a battery.

### REFERENCE SIGNS LIST

S10 method of estimating a state of deterioration of a battery
S20 method of estimating a state of deterioration of a battery

What is claimed is:

1. A method of estimating a state of deterioration of a battery having an electrode stack having current collector foil, and an outer casing containing the electrode stack, the method comprising:
calculating a difference between a temperature T₁ when temperature begins to drop, and a temperature T₂ when the temperature begins to rise and defining the difference as a temperature difference ΔT₁₂ if the following are all satisfied based on detected information on the temperature: the temperature of the battery drops; the temperature changes at a predetermined rate; the temperature drops in a predetermined range or wider; and the temperature is in a predetermined temperature range or under;
classifying the T₁ and the ΔT₁₂, and accumulating a number of times when a condition of the temperature belongs to any of the classifications; and
estimating damage to the current collector foil at present based on respective relationships between the classifications and damage to the current collector foil, the relationships being obtained in advance.
